(19) United States
(12) Patent Application Publication
(10) Pub. No.: US 2026/0308327 A1
(43) Pub. Date: Oct. 8, 2026

(54) ORGANOSILICON COMPOSITIONS

(71) Applicant: WACKER CHEMIE AG, Munich (DE)

(72) Inventors: Fanghua LEI, Shanghal (CN); Dongbing JIN, Shanghal (CN); Yun LIN, Shanghal (CN)

(73) Assignee: WACKER CHEMIE AG, Munich (DE)

(21) Appl. No.: 19/479,363

(22) PCT Filed: Jun. 29, 2023
(86) PCT No.: PCT/CN2023/103912

§ 371 Date: Oct. 28, 2025

(51) Int. Cl. C08G 77/18

(52) U.S. Cl. CPC C08G 77/18

(57) ABSTRACT

Organosilicon compositions and uses for the same. Where the composition includes a Component (1) Silicone Hydrophobic Agents and a Component (2) Polyether-modified Polysiloxane of formula I

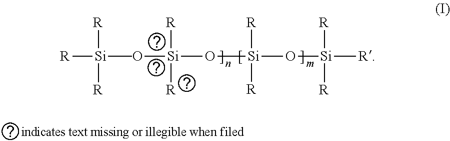

### FIELD OF THE INVENTION

The present disclosure relates to water-repellent material, especially relates to use of Organosilicon Compositions for mass hydrophobization of cement-based materials.

### BACKGROUND OF THE INVENTION

Inorganic building materials such as concrete and mortar have many micropores and capillaries which are easily penetrated by moisture and water, causing damage to the structure of the building such as steel corrosion, freeze-thaw damage, alkali-aggregate reaction, etc., seriously affecting its service life. It is therefore necessary to provide waterproof protection to the building surface. Silicon-organic compounds have long been used in building protection because of their excellent impregnating effect to repel water and dirt, their environmental friendliness, and their physiological acceptability.

Silicon-organic compounds have long been used in building protection because of their excellent impregnating effect to repel water and dirt, their environmental friendliness, and their physiological acceptability.

Customary impregnants contain alkoxysilanes having a hydrophobic alkyl group, with alkyl groups having 8 carbon atoms, in particular n-octyl groups or 1,4,4-trimethylpentyl groups, being particularly widely used. Typical representatives of such hydrophobicizing silanes are n-octyltriethoxysilane and 1,4,4-trimethylpentyltriethoxysilane.

Most commercially available compositions for hydrophobicizing building materials contain not only the abovementioned silanes but also further silicon-organic compounds, in particular methyl silicone resins, linear polydimethylsiloxanes or else linear polydimethylsiloxanes modified with, for example, amino groups. The corresponding mixtures can be applied neat, as a solution in an organic solvent or as aqueous emulsion.

In principle, a distinction can be made between two application forms. In the first, an existing construction, e.g. a concrete bridge, a house façade or a roof tile is subsequently hydrophobicized by means of a coating formulation. Here, the coating material applied can also penetrate into the substrate, at least in the case of porous building materials, and thus produce at least a certain effect at depth. In contrast to paints or varnishes applied exclusively to the surface, minor surface damage does not inevitably lead to a loss of the hydrophobic protective effect. However, greater damage or drilled holes, cut edges, sawn or broken edges lead to a loss of the protective effect at the places concerned in the case of exclusively surface-impregnated materials.

While subsequent surface hydrophobization is usually the only practical impregnation method for existing constructions, in the production of components based on hydraulic binders, e.g. concrete or fibrocement, the hydrophobicizing agent can be added before the setting process. This bulk hydrophobization, also known as mass hydrophobization, has the advantage that in this way the entire volume of the component and not only the surface thereof is provided with water-repellent protection. The protective action is thus not lost when the component is damaged or intentionally sawn or provided with drilled holes. In addition, bulk hydrophobization saves the additional working step of subsequent coating of the cured component.

CN112939512A discloses a dry powder waterproofing agent for bulk hydrophobization of cement-based materials by addition prior to cement curing, which adds polyether trisiloxane to improve the dispersion of the stearate. However, its hydrophobic effect is not as satisfactory as that of silane waterproofers.

CN1106363C discloses a process to produce integrally waterproofed concrete in which an aqueous hydrolysable emulsion comprising organosilicon compounds is added before curing to the fresh concrete mix prepared from water, inorganic and optionally organic constituents, which emulsion contains at least one alkoxysilane and optionally an organosilicon compound acting as a surfactant.

Although these organosilicon agents show excellent ability in mass hydrophobization, it will reduce the strength of concrete with higher content for lower strength, because organosilicon delays the hydration process of concrete. To balance the strength of the concrete, it is necessary to reduce the dosage of organosilicon agents in cement-based materials. meanwhile, their waterproofing properties do not perform at optimum levels. There is a lack of a silicone-based hydrophobic agent on the market that can guarantee the strength of building substrates such as cement mortar and achieve a further breakthrough in waterproofing performance.

Due to its amphiphilicity, Polyether-modified Polysiloxane is used as a surfactant in a wide range of applications, but there is no research or application of Polyether-modified Polysiloxane as a hydrophobic agent. Polyether-modified silanes are listed in CN1106363C as a surfactant for silicone waterproofing emulsions. CN111620659A discloses a self-leveling cement waterproof mortar comprising organosilicon and Polyether-modified Polysiloxane. CN114787100A discloses the use of Polyether-modified Polysiloxane as grinding clinker for cement preparation and does not mention its use in waterproofing. CN106116692B discloses a water repellent emulsion comprising octyltriethoxysilane with a Polyether-modified Polysiloxane, the Polyether-modified Polysiloxane was used as a co-emulsifier.

### SUMMARY OF THE INVENTION

The term “cement-based materials” refers to materials that set and continue to harden and gain strength by hydration process. Known cement according to the main hydraulic materials includes Portland cement, aluminate cement, sulfoaluminate cement, fluoroaluminate cement and ferroaluminate cement. In an embodiment herein, the cement accounts for at least 70 wt %, for example at least 80 wt %, at least 90 wt %, at least 95 wt %, even 100 wt % of the total weight of cement-based material.

The cement-based materials contain dry mixtures. The dry mixtures (i.e. dry mortar) may contain one or more of aggregates, polymers and admixtures other than cement. The admixtures include but are not limited to starch ethers, water-repellent agents, anticoagulants, retarders, superplasticizers and defoamers.

The cement-based materials contain flowable mixtures. The flowable mixtures can be exemplified by slurry materials obtained from cement or mixtures of cement and other materials by mixing with water, including paste, mortar, grout, and concrete, but not limited thereto. Paste is generally a mixture comprising cement, admixtures, and water. Mortar is generally a mixture comprising cement, sand, admixtures, and water. Grout is generally a mixture comprising cement, sand, polymers, admixtures, and water. Concrete is generally a mixture comprising cement, sand, stone, admixtures, and water. Wherein the polymers are added generally at an amount of greater than 1 wt % based on the total weight of cement. Wherein the admixtures are added generally at an amount of less than 3 wt % based on the total weight of cement.

“Silica fume” is a fine grained material comprising at least 85 wt % of amorphous silicon dioxide obtained as by products in production of ferrosilicon or industrial silicon (referring to GB/T27690-2011 standard).

“Silicone Hydrophobic Agents” refers to any materials with silicone-based components prominently used to minimize water absorption and ensure a water-repellent effect on cleaned surfaces.

“Mass hydrophobization” refers to the waterproofing agent mixed into the cement-based materials before cement curing, so that the distribution of the waterproofing agent in the cement-based materials to achieve the overall waterproofing, also known as internal waterproofing or bulk hydrophobization, which is different from the dipping or coating. water-repellent, waterproofing and hydrophobization have the same meaning in the present disclosure.

“Strength loss” refers to the reduction in strength of cement-based materials after hardening compared to the blank without hydrophobic agents, Strength loss=blank strength−example strength. Reducing strength loss can improve strength retention.

“Decrease in water absorption” refers to the reduction in water absorption of cement-based materials after hardening compared to the blank without hydrophobic agents, Decrease in water absorption=water absorption of blank-water absorption of example. A more decrease in water absorption means better the waterproof performance.

The “hardened cement-based materials” herein refers to cement-based materials that have transformed to a solid or almost solid state through a hardening process. The “hardening” herein corresponds essentially to hydration (or setting) of cement or mixtures comprising cement. In the sense of the disclosure, a hardened cement-based material is not necessarily a fully hardened one, it is one that is hydrated either partially or fully to gain a certain mechanical strength. A fully hardened cement-based material is one whose hydration is 100% complete.

Inventor discovered that there is a synergy between the Polyether-modified Polysiloxane of the present disclosure and Silicone Hydrophobic Agents for mass hydrophobization of the cement-based materials, which significantly improves waterproofing with little increase in the strength loss of Silicone Hydrophobic Agents on hardened cementitious materials.

Excellent improvements in water repellency of the hardened cement-based materials are obtained when the compositions of the present disclosure comprising the specific Polyether-modified Polysiloxane and Silicone Hydrophobic Agents are used as an admixture for mass hydrophobization of the cement-based materials with no significant loss of strength, especially compressive strength, which is not the case with these conventional Silicone Hydrophobic Agents.

The first aspect of the present disclosure provides a composition, which comprising Component (1) Silicone Hydrophobic Agents and Component (2) Polyether-modified Polysiloxane of formula I;

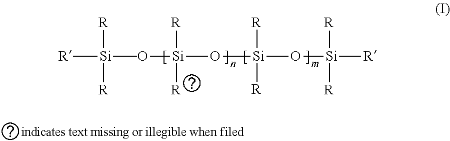

wherein each R independently represents monovalent hydrocarbon radical having from 1 to 30 carbon atoms, preferably monovalent hydrocarbon radical having from 1 to 6 carbon atoms, more preferably monovalent alkyl radical having from 1 to 6 carbon atoms, such as methyl, ethyl radicals;
R′ independently represents R or R*;

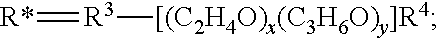

R³═—(CH₂)ₚO—, p selected from 2-10; preferably 2, 3, 4, 5, 6, more preferably 3 or 4; R⁴ selected from hydrogen, alkyl, aralkyl, aryl or R—C(O)—, preferably hydrogen, methyl, acetyl, more preferably hydrogen and methyl;
x selected from 1-60, preferably 1-40, more preferably 1-20;
y selected from 0-60, preferably 0-40, more preferably 0-20;
The value of x plus y is selected from 2-60, preferably 3-40, more preferably 10-30;
n selected from 0-20, preferably 0-15, more preferably 0-10;
m selected from 1-20, preferably 5-20, more preferably 5-15;
The value of n plus m is selected from 3-40, preferably 5-30 more preferably 10-20;
with the proviso that when n=0, at least one R′ is selected from R*.

The aforesaid Component (1) Silicone Hydrophobic Agents, comprising silanes of the formula II; and/or the hydrolyzates of silanes of the formula II; and/or the oligomers of silanes of the formula II.

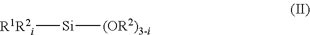

Wherein R¹ is a monovalent, optionally substituted, SiC-bonded hydrocarbon radical having from 1 to 16 carbon atoms, which may be interrupted by heteroatoms and/or carbonyl groups;

The example of R¹ is alkyl, such as methyl, ethyl, n-propyl, isopropyl, n-butyl, isobutyl, tert-butyl, n-pentyl, iso-pentyl, neopentyl and tert-pentyl radicals; Hexyl radicals, such as n-hexyl radical; octyl radicals such as n-octyl radical and iso-octyl radicals, such as 2,2,4-trimethylpentyl radical; Nonyl radicals, such as n-nonyl radical; decyl radicals, such as the n-decyl radical and dodecyl radicals, such as n-dodecyl radical; cycloalkyl radicals, such as cyclopentyl, cyclohexyl, 4-ethylcyclohexyl and cycloheptyl radicals, norbornyl radicals and methylcyclohexyl radicals.

The example of R¹ is alkenyl radicals, such as the vinyl, allyl, n-5-hexenyl, 4-vinylcyclohexyl and 3-norbornenyl radicals;

The example of R¹ is aryl radicals, such as the phenyl, biphenylyl, naphthyl, anthryl and phenanthryl radicals; alkaryl radicals, such as o-, m- and p-tolyl radicals, xylyl radicals and ethylphenyl radicals; aralkyl radicals, such as the benzyl radical, the alpha-phenylethyl and the beta-phenylethyl radical.

The example of R¹ is halogen-substituted alkyl radicals are alkyl radicals substituted by fluorine, chlorine, bromine, and iodine atoms, such as the 3,3,3-trifluoro n-propyl radical, the 2,2,2,2′,2′,2′-hexafluoroiso-propyl radical and the heptafluoroisopropyl radical. The example of R¹ is halogenated aryl groups such as o-chlorophenyl, m-chlorophenyl and p-chlorophenyl.

Preferably, R¹ is hydrocarbon radical having from 3 to 16 carbon atoms, more preferably R¹ is alkyl having from 3 to 8 carbon atoms, such as octyl radicals, butyl radicals.

R² is independently at each occurrence a monovalent, optionally substituted, SiC-bonded hydrocarbon radical having from 1 to 8 carbon atoms, which may be interrupted by heteroatoms and/or carbonyl groups;

Preferably, R² is alkyl radical having from 1 to 8 carbon atoms, such as methyl, ethyl, n-propyl, isopropyl, n-butyl, isobutyl, tert-butyl, n-pentyl, iso-pentyl, neopentyl and tert-pentyl radicals; Hexyl radicals, such as n-hexyl radical; octyl radicals such as n-octyl radical and iso-octyl radicals, such as 2,2,4-trimethylpentyl radical; more preferably methyl, ethyl, n-propyl, isopropyl.

The example of OR² is alkoxy radicals, such as methoxy, ethoxy, n-propoxy, isopropoxy, n-butoxy, isobutoxy, sec-butoxy and tert-butoxy radicals; pentyloxy radicals, such as the n-pentyloxy radical, or hexyloxy radicals, such as the n-hexyloxy radical. The ethoxy and methoxy radicals are particularly preferred. The alkoxy radicals may be substituted by halogen atoms, but this is not preferred.

i selected from 0-3, preferably 0 or 1, more preferably 0.

The aforesaid hydrolyzates usually form through elimination of some of the OR³ radicals in the silanes of formula II by reaction with water or water vapor, forming silicon-bonded OH groups.

The aforesaid oligomers usually form through elimination of some of silicon-bonded OH groups in the hydrolyzates of silanes of the formula II, which may also contain OH and OR³ groups.

Specifically, the aforesaid Component (1) Silicone Hydrophobic Agents can be any common silicone waterproof agent on the market, including silanes, hydrolyzates of silanes, oligomers of silane, polysiloxanes or a mixture of them.

In an embodiment herein, the Component (1) Silicone Hydrophobic Agents are alkoxysilanes including or are selected from a group consisting of butyltrimethoxysilane, butyltriethoxysilane, isobutyltrimethoxysilane, isobutyltriethoxysilane, octyltrimethoxysilane, octyltriethoxysilane, isooctyltrimethoxysilane, isooctyltriethoxysilane, octylmethyldimethoxysilane, octylmethyldiethoxysilane, isooctylmethyldimethoxysilane, isooctylmethyldiethoxysilane, dodecyltrimethoxysilane, dodecyltriethoxysilane, n-decyltrimethoxysilane, n-decyltriethoxysilane, propyltriisopropoxysilane, propyltriisobutoxysilane, hexyltriisopropoxysilane, hexyltriisopropoxysilane n-octyl triisopropoxysilane, n-octyl triisopropoxysilane, n-octyl methyl diisopropoxysilane, n-octyl triisopropoxysilane, n-octyl triisopropoxysilane, n-octyl methyl diisopropoxysilane, n-octyl methyl diisopropoxysilane, n-octyl triisopropoxysilane, n-octyl triisobutoxysilane, n-octyl triisobutoxysilane, n-octyl methyl diisobutoxysilane, n-octyl methyl diisobutoxysilane n-decyltriisopropoxysilane, n-decylmethyldiisopropoxysilane, n-decyltriisobutoxysilane, n-decylmethyldiisobutoxysilane, dodecyltriisopropoxysilane, dodecylmethyldiisopropoxysilane, dodecyltriisobutoxysilane, dodecylmethyldiisobutoxysilane, cetyltriisopropoxysilane, cetylmethyldiisopropoxysilane, cetyl triisobutoxysilane, cetylmethyldiisobutoxysilane. In this embodiment, the alkoxysilanes may also include partial hydrolyzates or oligomers of the aforesaid silanes.

Preferably, the alkoxysilanes are selected from a group consisting of butyltrimethoxysilane, butyltriethoxysilane, isobutyltrimethoxysilane, isobutyltriethoxysilane, octyltrimethoxysilane, octyltriethoxysilane, isooctyltrimethoxysilane, isooctyltriethoxysilane, octylmethyldimethoxysilane, octylmethyldiethoxysilane, isooctylmethyldimethoxysilane, isooctylmethyldiethoxysilane, n-octyltriisopropoxysilane, isooctyltriisopropoxysilane, n-octylmethyldiisopropoxysilane, isooctylmethyldiisopropoxysilane, dodecyltrimethoxysilane, dodecyltriethoxysilane, n-decyltrimethoxysilane, n-decyltriethoxysilane and partial hydrolyzates or oligomers thereof.

More preferably, the alkoxysilanes are selected from a group consisting of butyltrimethoxysilane, butyltriethoxysilane, isobutyltrimethoxysilane, isobutyltriethoxysilane, octyltrimethoxysilane, octyltriethoxysilane, isooctyltrimethoxysilane, isooctyltriethoxysilane, n-octyltriisopropoxysilane, isooctyltriisopropoxysilane and partial hydrolyzates or oligomers thereof. Further preferred comprising silane oligomers, such as selected from a group consisting of butyltrimethoxysilane, butyltriethoxysilane, isobutyltrimethoxysilane, isobutyltriethoxysilane, octyltrimethoxysilane, octyltriethoxysilane, isooctyltrimethoxysilane, isooctyltriethoxysilane oligomers thereof.

Preferably, the aforesaid silane oligomers with a viscosity of 3-1000 mm2/s, 25° C., more preferably with viscosity of 3-500 mm2/s, 25° C., further preferably with viscosity of 3-300 mm2/s, 25° C.

The aforesaid Component (2) Polyether-modified Polysiloxane of formula I

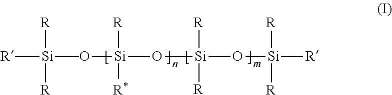

wherein each R independently represents a monovalent hydrocarbon radical having from 1 to 30 carbon atoms;

The example of R is methyl, ethyl, n-propyl, isopropyl, n-butyl, isobutyl, tert-butyl, n-pentyl, iso-pentyl, neopentyl and tert-pentyl radicals; Hexyl radicals, such as n-hexyl radical; octyl radicals such as n-octyl radical and iso-octyl radicals, such as 2,2,4-trimethylpentyl radical; Nonyl radicals, such as n-nonyl radical; decyl radicals, such as the n-decyl radical and dodecyl radicals, such as n-dodecyl radical; cycloalkyl radicals, such as cyclopentyl, cyclohexyl, 4-ethylcyclohexyl and cycloheptyl radicals, norbornyl radicals and methylcyclohexyl radicals. aryl radicals, such as the phenyl, biphenylyl, naphthyl, anthryl and phenanthryl radicals; alkaryl radicals, such as o-, m- and p-tolyl radicals, xylyl radicals and ethylphenyl radicals; aralkyl radicals, such as the benzyl radical, the alpha-phenylethyl and the beta-phenylethyl radical.

The example of R is halogen-substituted alkyl radicals are alkyl radicals substituted by fluorine, chlorine, bromine and iodine atoms, such as the 3,3,3-trifluoro n-propyl radical, the 2,2,2,2′,2′,2′-hexafluoroiso-propyl radical and the heptafluoroisopropyl radical. The example of R is halogenated aryl groups such as o-chlorophenyl, m-chlorophenyl and p-chlorophenyl.

Preferably, R represents a monovalent hydrocarbon radical having from 1 to 6 carbon atoms, more preferably R represents a monovalent alkyl radical having from 1 to 6 carbon atoms, such as methyl, ethyl radicals.

R′ independently represents R or R*;

R*═R³—[(C₂H₄O)ₓ(C₃H₆O)_{y}]R⁴;
R³═—(CH²)ₚO—, p selected from 2-10; preferably 2, 3, 4, 5, 6, more preferably 3 or 4;
R⁴ represents hydrogen, alkyl, aralkyl, aryl or R—C(O)—;
The example of R⁴ is Hydrogen, methyl, ethyl, n-propyl, isopropyl, butyl, hexyl, decyl, dodecyl, 2-phenylethyl, phenyl, acetyl, preferably hydrogen, methyl, acetyl, more preferably hydrogen and methyl;
x selected from 1-60, preferably 1-40, more preferably 1-20, such as 7, 8, 9, 10, 11, 12, 13, 14, 15, 16, 17;
y selected from 0-60, preferably 0-40, more preferably 0-20, such as 0, 1, 2, 3, 4, 5, 6, 7, 8, 9, 10;
y selected from 0-10, preferably 0-5, more preferably 0.
The value of x plus y is selected from 2-60, preferably 3-40, more preferably 10-30, such as 11, 12, 13, 14, 15, 16, 17, 18, 19, 20, 21, 22, 23, 24, 25, 26;
The value of y/x is selected from 0-3, preferably 0-1, such as 0, 0.1, 0.2, 0.3, 0.4, 0.5, 0.6, 0.7, 0.8, 0.9, more preferably 0;
n selected from 0-20, preferably 0-15, more preferably 0-10, such as 0, 1, 2, 3, 4, 5, 6, 7, 8, 9, 10;
m selected from 1-20, preferably 5-20, more preferably 5-15, such as 5, 6, 7, 8, 9, 10, 11, 12, 13, 14, 15;
The value of n plus m is selected from 3-40, preferably 5-20, more preferably 10-20, such as 11, 12, 13, 14, 15, 16, 17, 18, 19, 20;
with the proviso that when n=0, at least one R′ is selected from R*.

Preferably, the aforesaid Component (2) Polyether-modified Polysiloxane is selected from Polyether-modified Polysiloxane of formula III or IV;

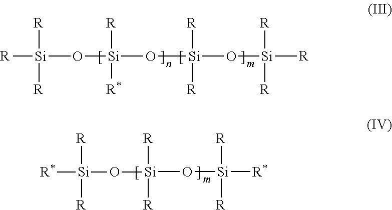

wherein R, R*, n and m are as defined in formula I, and n is greater than 0.

The aforesaid Component (2) Polyether-modified Polysiloxane of formula I with a viscosity of 50-700 mm²/s, 25° C., more preferably with viscosity of 100-500 mm²/s, 25° C., further preferably with viscosity of 150-400 mm²/s, 25° C.

In the present disclosure, the compositions comprising Component (1) Silicone Hydrophobic Agents and Component (2) Polyether-modified Polysiloxane of formula I, should be understood that Component (1) Silicone Hydrophobic Agents and Component (2) Polyether-modified Polysiloxane of formula I are main component of the compositions. The compositions may also contain components for dissolving or stably dispersing them, or components as a dispersion medium for them, but these components are not regarded as main components. Herein the main component can also be understood that the Component (1) Silicone Hydrophobic Agents and Component (2) Polyether-modified Polysiloxane of formula I account for at least 20 wt % of the total weight of the composition, preferably at least 40 wt %, more preferably at least 50 wt %, such as 55%, 60%, 65%, 70%, 75%, 80%.

Wherein the weight ratio of Component (2) to Component (1) is selected from 0.01-80, such as 0.02-80, 0.02-70, 0.02-60, 0.02-50, 0.02-40, 0.02-30, preferably 0.02-20, such as 0.03-10, 0.03-5, 0.03-3, 0.03-2, more preferably 0.03-1.5, such as 0.1, 0.2, 0.3, 0.4, 0.5, 0.6, 0.7, 0.8, 0.9, 1, 1.1, 1.2, 1.3, 1.4.

Wherein the compositions comprising 20-80 wt % of Component (1) and 20-80 wt % of Component (2), preferably 30-70 wt % of Component (1) and 30-70 wt % of Component (2), more preferably 40-60 wt % of Component (1) and 40-60 wt % of Component (2), based on 100 wt % of the composition.

The second aspect of the present disclosure provides a waterproof emulsion, which contains the aforesaid composition, water, and emulsifier.

The composition may be a self-dispersable system comprising the aforesaid Component (1) and Component (2), especially an emulsion comprising the same. The “self-dispersable system” herein refers to a dispersion or suspension of Component (1) and Component (2) in an emulsifier, water, or an organic solvent such as alkanol for example ethanol or glycerin, or a non-solvent liquid carrier. The term “emulsion” includes a simple direct emulsion (oil-in-water), an inverse emulsion (water-in-oil), or a multiple emulsion (eg, water-in-oil-in-water, oil-in-water-in-oil).

In an embodiment of the present disclosure, the Component (1) and Component (2) are used as admixture in an emulsion form for mass hydrophobization of cement-based materials. The emulsion comprises the aforesaid Component (1) and the aforesaid Component (2), an emulsifier (3) and water (4). The content of Component (1) and Component (2) in the emulsion is not particularly limited and is suitably from 20 wt % to 60 wt %, preferably from 30 wt % to 55 wt %, more preferably 35 wt % to 50 wt %.

The emulsifier (3) may be any emulsifier for producing silane dispersions used heretofore, such as anionic, cationic, nonionic and amphoteric surfactants, or a mixture thereof, preferably a nonionic emulsifier. Examples of suitable nonionic emulsifiers include fatty alcohol polyoxyethylene ethers, fatty acid polyoxyethylene esters, ethylene oxide-propylene oxide copolymers, sorbitan fatty acid esters, ethoxylated sorbitan fatty acid esters, pentaerythritol fatty acid esters, glycerol fatty acid esters, and mixtures thereof. Preferences are given to fatty alcohol polyoxyethylene ethers having from 10 to 20 carbon atoms, fatty acid polyoxyethylene esters, sorbitan fatty acid esters, ethoxylated sorbitan fatty acid esters, and mixtures thereof. The nonionic emulsifier preferably comprises at least one nonionic emulsifier with an HLB value of equal to or more than 12.

The emulsifier is preferably used in a minimum amount to stabilize the emulsion, for example 0.01-5 wt %, or even 0.1-3 wt %, preferably 0.1-2 wt %, more preferably 0.1-1 wt % based on the total weight of the emulsion, since it may reduce the strength of the hardened cement-based materials.

The content of water (4) in the emulsion is not particularly limited and is suitably from 35 wt % to 75 wt %, preferably from 40 wt % to 65 wt %, more preferably 45 wt % to 60 wt %. The emulsion may further comprise an appropriate amount of other optional components (5), for example a pH adjuster, an antifreeze agent and a preservative, as long as they do not impair the realization of the present invention.

The emulsion is preferably free of water immiscible solvents, nanofillers, other hydrophobic components and other silicon compounds. The “water immiscible solvents” refer to solvents which are soluble with water in amounts of not more than 1 g/L at 20° C. and a pressure of 101 kPa, for example benzene, toluene, xylene, hexane and cyclohexane. Examples of nanofillers include but not limited to nano aluminum oxide, nano aluminum hydroxide, nano calcium oxide and nano zinc oxide. The other hydrophobic components can be exemplified by stearic acid, calcium stearate, zinc stearate, aluminum stearate, dodecanol, cetyl alcohol, stearyl alcohol, butyltrimethoxysilane, butyltriethoxysilane, octyltrimethoxysilane, octyltriethoxysilane, isooctyltrimethoxysilane, isooctyltriethoxysilane, dodecyltrimethoxysilane, dodecyltriethoxysilane, n-decyltrimethoxysilane, n-decyltriethoxysilane, but not limited thereto. The other silicon compounds refer to compounds comprising silicon atoms other than the alkoxysilanes or alkoxysiloxanes (a), polysiloxane (d) and aminosilane (e), for example bis-(γ-trimethoxysilylpropyl) amine, bis-(γ-triethoxysilylpropyl) amine, polysiloxanes comprising no aminoalkyl. In the present disclosure, “free of” means that the ingredient is present in the emulsion in an amount of less than 1 wt %, even less than 0.5 wt %, 0.1 wt %, or 0.01 wt % of the total weight of the emulsion.

The emulsions comprising the aforesaid composition can be prepared by a method known in the art.

The third aspect of the present disclosure provides a waterproof powder, which contains the aforesaid composition and solid carriers.

In the present disclosure, the aforesaid Component (1) and Component (2) can also be adsorbed on a solid carrier and used as admixture in a powder form for mass hydrophobization of the cement-based materials. Considering that the aforesaid Component (1) Silicone Hydrophobic Agents and component (2) Polyether-modified Polysiloxane of formula I are not easy to be adsorbed directly to the cement-containing cementitious materials, it is preferred to have them adsorbed on a solid carrier (6) first and then mixed into the cement-based materials. Suitable solid carriers (6) are generally porous materials, including but not limited to silica fume, silica, alumina, activated carbon, talc, zeolite powder, calcium carbonate, calcium silicate, diatomaceous earth and clay.

The aforesaid powder comprises the aforesaid Component (1) and the aforesaid Component (2) and solid carriers (6). The content of Component (1) and Component (2) in the emulsion is not particularly limited and is suitably from 10 wt % to 50 wt %, preferably from 15 wt % to 40 wt %, more preferably 20 wt % to 30 wt %.

The content of solid carriers (6) in the powder is not particularly limited and is suitably from 50 wt % to 90 wt %, preferably from 60 wt % to 85 wt %, more preferably 70 wt % to 80 wt %.

The aforesaid powder having the amount of water less than 1 wt %, preferably less than 0.5 wt % or 0.2 wt %, more preferably 0.1 wt % or 0.01 wt % of the total weight of the powder.

The fourth aspect of the present disclosure provides the use of the aforesaid composition, the aforesaid emulsion, or the aforesaid powder for mass hydrophobization of cement-based materials, especially to reduce the strength loss.

In the present disclosure, the compositions comprising Component (1) Silicone Hydrophobic Agents and Component (2) Polyether-modified Polysiloxane of formula I are mixed into the cement-based materials for mass hydrophobization at an active ingredient dosage of from 0.1% to 3% preferably from 0.1% to 2%, such as 0.2, 0.3, 0.4, 0.5, 0.6, 0.7, 0.8, 0.9, 1.0, 1.1, 1.2, 1.3, 1.4, 1.5, 1.6, 1.7, 1.8, especially from 0.1% to 1% by mass of total cement. If the dosage is too low, the water repellency of the cement-based material is undesired. If the dosage is too high, the water repellency may not be further improved but it may result in an increased cost and a significant loss of strength of the hardened cement-based material. In the context of the disclosure, the active ingredients comprise Component (1) Silicone Hydrophobic Agents and Component (2) Polyether-modified Polysiloxane of formula I. Preferably, the Component (1) Silicone Hydrophobic Agents and Component (2) Polyether-modified Polysiloxane of formula I account for at least 95 wt %, even at least 98 wt %, at least 99 wt % of the total weight of active ingredients. In the case that Component (1) Silicone Hydrophobic Agents and Component (2) Polyether-modified Polysiloxane of formula I are used as an admixture in an emulsion form, the dosage is calculated as a percentage of the mass of Component (1) Silicone Hydrophobic Agents and Component (2) Polyether-modified Polysiloxane of formula I to the total mass of cement.

The method for mass hydrophobization of cement-based materials is not particularly limited, as long as the aforesaid compositions as water-repellent admixture are mixed well into the cement-based materials before setting and hardening. The water-repellent admixture may be incorporated in the process of preparation or post-treatment of cement-based materials, or in the process of post-treatment of raw materials for preparing the cement-based materials. The water-repellent admixture can also be incorporated in the process of post-treatment of the cement-based materials, specifically, for example added to treat the prepared cement; the water-repellent admixture can also be incorporated in the process of preparation of dry mixtures or flowable mixtures comprising cement, specifically, for example added in the process of preparation of paste, mortar, grout or concrete; furthermore the water-repellent admixture can also be incorporated in the process of post-treatment of raw materials for preparing the cement-based materials such as aggregates e.g. sand, stone, polymers and admixtures.

In an embodiment herein, the compositions comprising Component (1) Silicone Hydrophobic Agents and Component (2) Polyether-modified Polysiloxane of formula I as water-repellent admixture are added in the process of preparation of flowable mixtures, and then the well mixed flowable mixtures transform to a solid or almost solid state though a setting and hardening process. In the case that the aforesaid compositions are used as admixture in an emulsion form, the emulsion may be mixed into water, and then the resultant wet mix is added to the dry mix comprising cement-based materials to mix well. In the case that t the aforesaid compositions are used as admixture in a powder form, the powder may be mixed into cement-based materials and other dry materials followed by addition of water to mix well.

The fifth aspect of the present disclosure provides a cement-based materials, which contains the aforesaid composition, or waterproof emulsion, or the waterproof powder, at an active ingredient dosage of 0.1-3 wt % by mass of total cement, preferably 0.1-2 wt %, such as 0.2, 0.3, 0.4, 0.5, 0.6, 0.7, 0.8, 0.9, 1.0, 1.1, 1.2, 1.3, 1.4, 1.5, 1.6, 1.7, 1.8, preferably from 0.1% to 1%, active ingredient comprises Component (1) Silicone Hydrophobic Agents and Component (2) Polyether-modified Polysiloxane of formula I, preferably the active ingredient consists of Component (1) Silicone Hydrophobic Agents and Component (2) Polyether-modified Polysiloxane of formula I.

The cement-based materials of the present disclosure have a high water-repellency with the Rate of Decrease in 24 h Water Absorption higher than 72%, such as 73%, 74%, 75%, 76%, 77%, 78%, 79%, 80%, preferably, higher than 75%, more Preferably, higher than 80%, based on Blank without hydrophobic agents (Tested according to standard JGJ/T 70-2009).

The cement-based materials of the present disclosure have a small strength loss with Retention of compressive Strength-28d based on Blank higher than 80% such as 81%, 82%, 83%, 84%, 85%, 86%, 87%, 88%, 89%, 90%, 91%, 92%, 93%, 94%, 95%, Preferably, higher than 83%, more preferably higher than 85%, based on Blank without hydrophobic agents (Tested according to standard JGJ/T 70-2009).

### DETAILED DESCRIPTION OF THE PREFERRED EMBODIMENTS

Silicone Hydrophobic Agent 1: octyltriethoxysilane oligomer (purity 99%); viscosity 130-300 mm²/s, 25° C. (Tested according to standard DIN 51562-1);
Silicone Hydrophobic Agent 2: octyltriethoxysilane (purity 99%);
Polyether-modified Polysiloxane 1: belongs to the aforesaid formula (I), n=4, m=10; viscosity 327 mm2/s, 25° C. (Tested according to DIN 51562-1), as shown in formula a (purity 99%):

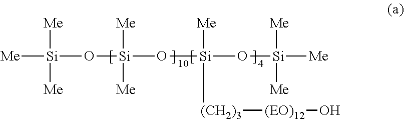

Polyether-modified Polysiloxane 2: belongs to the aforesaid formula (I), n=0, m=15, viscosity 200 mm²/s, 25° C. (Tested according to DIN 51562-1), as shown in formula b (purity 99%):

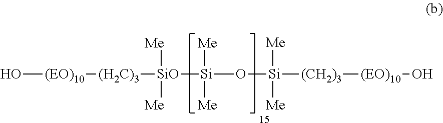

Polyether-modified Polysiloxane 3: an admixture with the molar ratio of n=4.5, m=70 to n=8, m=42 is 2:1, viscosity 800 mm²/s, 25° C. (Tested according to DIN 51562-1), as shown in formula c (purity 99%):

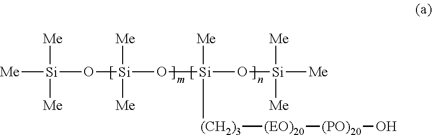

Polyether-modified Polysiloxane 4: belongs to the aforesaid formula (I), but n=1, m=0, viscosity 10-25 mm²/s, 25° C. (Tested according to DIN 51562-1), as shown in formula d (purity 99%):

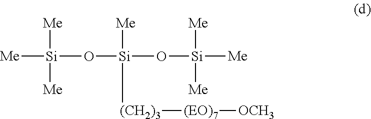

The above substances were provided by WACKER Chemie AG.

All viscosity data in this disclosure are measured according to DIN 51562-1.
Oleic Acid: commercially available, purity 99%.
Cement: Special benchmark cement for concrete admixture testing, Executive Standard GB8076-2008 Appendix A.
Sand: ISO standard sand, implementation standard GB/T1761-1999.
Composition: prepared by mixing the above Silicone Hydrophobic Agents and/or Polyether-modified Polysiloxanes or Oleic acid, comprising a self-assembled structure formed by the Silicone Hydrophobic Agents and the Polyether-modified Polysiloxane, which is formed after mixing of the above, in the form of an oil mixture, an emulsion or a powder, without limitation.

The procedure of the waterproof emulsion preparation was the following:

Add 0.5-3 g of emulsifier and 0.5-5 g of water to the vessel, switch on the homogenizor (T25 with 25F stator and rotator) and start working at a speed of 1500 rpm, add 0-50 g of Silicone Hydrophobic Agents into the vessel at 2000 rpm in batches and homogenize at 2000 rpm for 3 min after each addition, add 0-50 g of Polyether-modified Polysiloxanes into the vessel at 2000 rpm in batches and homogenize at 2000 rpm for 3 min after each addition, add 47.5 g of water into the vessel at 2000 rpm in batches and homogenize at 2000 rpm for 3 min after each addition until the emulsion is homogeneous and stable.

The procedure of the waterproof powder preparation was the following:

Add 75 grams of silica fume to the vessel, switch on the mixer with the speed of 300 rpm, add 0-25 grams of Silicone Hydrophobic Agents into the vessel in batches and mixing at 300 rpm for 3 min after each addition, then add 0-25 grams of Polyether-modified Polysiloxanes into the vessel in batches and mixing at 300 rpm for 3 min after each addition, after which stirring is sufficient to obtain a powdered water repellent that can flow freely.

The procedure of the mortar preparation was the following:

Referring to the recipe in Table 1-3, add the Composition, water, and cement into the bowl, and fix the bowl to the mixer, start with a low mixing speed (140 rpm) for 30 seconds, then add the sand steadily during the next 30 seconds, then the mixer switch to high mixing speed (285 rpm) and continue the mixing for an additional 30 seconds; Then stop the mixer for 90 seconds. During the first 30s, remove by means of a rubber scraper the mortar adhering to the wall and bottom part of the bowl and place in the middle of the bowl. continue the mixing at the high speed (285 rpm) for 60 seconds (according to ISO EN 196-1). After the mortar was prepared, it was compacted to the mould to obtain cubic of 70.7×70.7×70.7 mm.

Keep the mortar in the mould at 90% relative humidity (RH) and temperature of (20±2° C.) for 24 hrs. After that demould the samples and put it back to the chamber with RH 90% and (20±2° C.), keep it there for 27 days more.

After 28 days make a measurement of water absorption and compressive strength (according to JGJ/T 70-2009), and the value of 24 h Water Absorption (%) and Compressive Strength-28d (Mpa) shown in table 1-3.

24 h Water Absorption (%) means the water absorption of the above mortar after immersed in water for 24 hours (according to JGJ/T 70-2009).

Compressive Strength-28d (Mpa) means the Compressive Strength of the above mortar at the age of 28 days (according to JGJ/T 70-2009).

TABLE 1
Examples and comparison examples of mortar

| | | Blank | C.Ex.1 | C.Ex.2 | Ex.3 | Ex.4 | C.Ex.5 | C.Ex.6 |
|---|---|---|---|---|---|---|---|---|
| Composition | Silicone | | 0.3 | 0.6 | 0.3 | 0.3 | | |
| | Hydrophobic | | | | | | | |
| | Agent 1 | | | | | | | |
| | Polyether- | | | | 0.3 | | 0.3 | |
| | modified | | | | | | | |
| | Polysiloxane | | | | | | | |
| | 1 | | | | | | | |
| | Polyether- | | | | | 0.3 | | 0.3 |
| | modified | | | | | | | |
| | Polysiloxane | | | | | | | |
| | 2 | | | | | | | |

| | | | | | | | |
|---|---|---|---|---|---|---|---|
| Cement | 100 | 100 | 100 | 100 | 100 | 100 | 100 |
| Sand | 300 | 300 | 300 | 300 | 300 | 300 | 300 |
| water | 50 | 50 | 50 | 50 | 50 | 50 | 50 |
| 24 h Water Absorption (%) | 6.1 | 1.8 | 1.1 | 1.2 | 1.5 | 5.5 | 5.7 |
| Rate of Decrease in Water | 0 | 70.5 | 82.0 | 80.3 | 75.4 | 9.8 | 6.6 |
| Absorption based on Blank | | | | | | | |
| (%) | | | | | | | |
| Compressive Strength-28 d | 43.4 | 37.2 | 31.3 | 37.0 | 37.1 | 38.3 | 39.2 |
| (Mpa) | | | | | | | |
| Retention of Compressive | 100 | 85.7 | 72.1 | 85.3 | 85.5 | 88.2 | 90.3 |
| Strength (%) based on | | | | | | | |
| Blank | | | | | | | |

Rate of Decrease in Water Absorption based on Blank (%)=(decrease in 24 h Water Absorption)/24 h Water Absorption of Blank=(24 h Water Absorption of Blank−24 h Water Absorption of example)/24 h Water Absorption of Blank.

Retention of Compressive Strength based on Blank (%)=(compressive strength−28 d loss)/compressive strength−28 d of Blank=(compressive strength−28 d of Blank−compressive strength−28 d of example)/compressive strength−28 d of Blank.

The results of the Blank and C. Ex. 1-2 in Table 1 shows that the 24 h water absorption was significantly reduced when only conventional Silicone Hydrophobic Agent 1 was used as the composition, but when the amount of Silicone Hydrophobic Agent 1 was further increased, the 24 h water absorption was further reduced but accompanied by a significant decrease in compressive strength.

In C. Ex. 5-6, the composition comprising only Polyether-modified Polysiloxane will reduce 24 h water absorption to some extent but will fall far short of the waterproofing required for practical applications.

The compositions of Ex. 3-4 comprising Silicone Hydrophobic Agent 1 and Polyether-modified Polysiloxane 1-2 were able to significantly reduce the 24 h water absorption compared to using only conventional Silicone Hydrophobic Agent 1 and were able to maintain no significant loss in strength. These Compositions are valuable in Mass hydrophobization of cement-based materials, achieving the Rate of Decrease in 24 h Water Absorption of higher than 72% and Retention of Compressive Strength of 80% based on Blank.

TABLE 2
Examples and comparison examples of mortar

| | | C.Ex.1 | Ex.3 | Ex.4 | C.Ex.7 | C.Ex.8 | C.Ex.9 |
|---|---|---|---|---|---|---|---|
| Composition | Silicone | 0.3 | 0.3 | 0.3 | 0.3 | 0.3 | 0.3 |
| | Hydrophobic Agent 1 | | | | | | |
| | Polyether-modified | | 0.3 | | | | |
| | Polysiloxane 1 | | | | | | |
| | Polyether-modified | | | 0.3 | | | |
| | Polysiloxane 2 | | | | | | |
| | Polyether-modified | | | | 0.3 | | |
| | Polysiloxane 3 | | | | | | |
| | Polyether-modified | | | | | 0.3 | |
| | Polysiloxane 4 | | | | | | |
| | Oleic acid | | | | | | 0.3 |

| | | | | | | |
|---|---|---|---|---|---|---|
| Cement | 100 | 100 | 100 | 100 | 100 | 100 |
| Sand | 300 | 300 | 300 | 300 | 300 | 300 |
| water | 50 | 50 | 50 | 50 | 50 | 50 |
| 24 h Water Absorption (%) | 1.8 | 1.2 | 1.5 | 1.7 | 1.8 | 1.4 |
| Rate of Decrease in Water | 0 | 33.3 | 16.7 | 5.6 | 0 | 22.2 |
| Absorption based on C.Ex.1 (%) | | | | | | |
| Compressive Strength-28 d (Mpa) | 37.2 | 37 | 37.1 | 35.3 | 31.1 | 29.5 |
| Retention of Compressive Strength | 100 | 99.5 | 99.7 | 94.9 | 83.6 | 79.3 |
| based on C.Ex.1 (%) | | | | | | |

Rate of Decrease in Water Absorption based on C. Ex. 1(%)=(decrease in 24 h Water Absorption)/24 h Water Absorption of C. Ex. 1=(24 h Water Absorption of C. Ex. 1-24 h Water Absorption of example)/24 h Water Absorption of C. Ex. 1.

Retention of Compressive Strength based on C. Ex. 1(%)=(compressive strength−28 d loss)/compressive strength−28 d of C. Ex. 1=(compressive strength−28 d of C. Ex. 1-compressive strength−28 d of example)/compressive strength−28 d of C. Ex. 1.

C. Ex. 7-8 of Table 2 shows that the addition of Polyether-modified Polysiloxane 3-4, which are not within the scope of the present application, and Silicone Hydrophobic Agent 1 in the mortar does not have a significant decrease in water absorption and a more severe decrease in compressive strength, compared with the use of only conventional Silicone Hydrophobic Agent 1 in C. Ex. 1 as a composition for mortar.

The addition of Oleic acid to Silicone Hydrophobic Agent 1 in C. Ex. 9 resulted in a more significant decrease in water absorption compared to C. Ex. 1. However, the loss of compressive strength was also more severe, and the Retention of Compressive Strength was only 68%.

The mortar of Ex. 3-4 has the compositions comprising Silicone Hydrophobic Agent 1 and Polyether-modified Polysiloxane 1-2 of the present application achieving the Rate of Decrease in 24 h Water Absorption of higher than 10% and Retention of Compressive Strength of 90% based on C. Ex. 1.

TABLE 3
Examples of mortar

| | | Ex.10 | Ex. 11 | Ex. 12 |
|---|---|---|---|---|
| Composition | Silicone Hydrophobic | 0.3 | 0.3 | 0.3 |
| | Agent 2 | | | |
| | Polyether-modified | | 0.3 | |
| | Polysiloxane 1 | | | |
| | Polyether-modified | | | 0.3 |
| | Polysiloxane 2 | | | |

| | | | |
|---|---|---|---|
| Cement | 100 | 100 | 100 |
| Sand | 300 | 300 | 300 |
| water | 50 | 50 | 50 |
| 24 h Water Absorption (%) | 1.9 | 1.5 | 1.7 |

Ex. 10-15 in Table 3 show that the Polyether-modified Polysiloxane of the present application can be used with various Silicone Hydrophobic Agents for mass hydrophobization in mortar, which shows excellent improvement in water repellency.

1-14. (canceled)

15. A composition, comprising:
a Component (1) Silicone Hydrophobic Agents and a Component (2) Polyether-modified Polysiloxane of formula I; 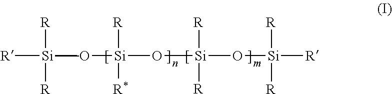
wherein each R independently represents a monovalent hydrocarbon radical having from 1 to 30 carbon atoms, preferably monovalent hydrocarbon radical having from 1 to 6 carbon atoms, more preferably monovalent alkyl radical having from 1 to 6 carbon atoms, such as methyl, ethyl radicals;
wherein R′ independently represents R or R*;
wherein R*═R³—[(C₂H₄O)ₓ(C₃H₆O)_{y}]R⁴;
wherein R³═—(CH₂)ₚO—, p selected from 2-10; preferably 2, 3, 4, 5, 6, more preferably 3 or 4; R⁴ selected from hydrogen, alkyl, aralkyl, aryl or R—C(O)—, preferably hydrogen, methyl, acetyl, more preferably hydrogen and methyl;
wherein x is selected from 1-60, preferably 1-40, more preferably 1-20;
wherein y is selected from 0-60, preferably 0-40, more preferably 0-20;
wherein the value of x plus y is selected from 2-60, preferably 3-40, more preferably 10-30;
wherein n is selected from 0-20, preferably 0-15, more preferably 0-10;
wherein m is selected from 1-20, preferably 5-20, more preferably 5-15;
wherein the value of n plus m is selected from 3-40, preferably 5-30 more preferably 10-20; and
wherein when n=0, at least one R′ is selected from R*.

16. The composition of claim 15, wherein the Component (2) is selected from Polyether-modified Polysiloxane of formula III or IV, 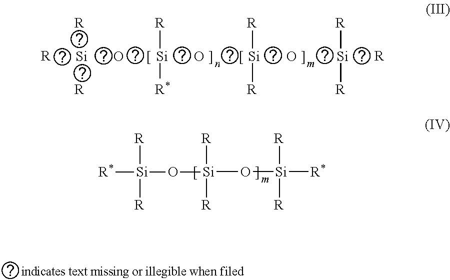
wherein R, R*, n and m are as defined in formula I, and n is greater than 0.

17. The composition of claim 15, wherein the value of y/x is selected from 0-3, preferably 0-1, more preferably 0; and/or y selected from 0-10, preferably 0-5, more preferably 0.

18. The composition of claim 16, wherein the value of y/x is selected from 0-3, preferably 0-1, more preferably 0; and/or y selected from 0-10, preferably 0-5, more preferably 0.

19. The composition of claim 15, wherein the Component (1) Silicone Hydrophobic Agents comprise silanes of the formula II, and/or the hydrolyzates of silanes of the formula II, and/or the oligomers of silanes of the formula II, 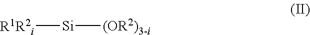
wherein R¹ is a monovalent, optionally substituted, SiC-bonded hydrocarbon radical having from 1-16 carbon atoms, which may be interrupted by heteroatoms and/or carbonyl groups, preferably hydrocarbon radical having from 3 to 16 carbon atoms, more preferably alkyl radical having from 3 to 8 carbon atoms, such as octyl radicals, butyl radicals;
wherein R² is independently at each occurrence a monovalent, optionally substituted, SiC-bonded hydrocarbon radical having from 1 to 8 carbon atoms, which may be interrupted by heteroatoms and/or carbonyl groups, preferably alkyl radical having from 1 to 8 carbon atoms, more preferably R² is methyl, ethyl, n-propyl or isopropyl; and
wherein i selected from 0-3, preferably 0 or 1, more preferably 0.

20. The composition of claim 15, wherein the Component (1) Silicone Hydrophobic Agents comprise silane oligomers, preferably, selected from a group consisting of butyltrimethoxysilane, butyltriethoxysilane, isobutyltrimethoxysilane, isobutyltriethoxysilane, octyltrimethoxysilane, octyltriethoxysilane, isooctyltrimethoxysilane, isooctyltriethoxysilane oligomers thereof; and/or
wherein the aforesaid silane oligomers with a viscosity of 3-1000 mm2/s, 25° C., more preferably with viscosity of 3-500 mm2/s, 25° C., further preferably with viscosity of 3-300 mm2/s, 25° C.

21. The composition of claim 15, wherein the composition comprises 20-80 wt % of the Component (1) and 20-80 wt % of the Component (2), preferably 30-70 wt % of the Component (1) and 30-70 wt % of the Component (2), more preferably 40-60 wt % of the Component (1) and 40-60 wt % of the Component (2), based on 100 wt % of the composition; and/or
wherein the weight ratio of the Component (2) to the Component (1) is selected from 0.01-80, preferably 0.02-20, more preferably 0.03-1.5; and/or
wherein the Component (1) Silicone Hydrophobic Agents and the Component (2) Polyether-modified Polysiloxane of formula I account for at least 20 wt % of the total weight of the composition, preferably at least 40 wt %, more preferably at least 50 wt %, such as 55%, 60%, 65%, 70%, 75%, 80%, based on 100 wt % of the composition.

22. The composition of claim 15, wherein the Component (2) has a viscosity of 50-700 mm²/s, 25° C., more preferably a viscosity of 100-500 mm²/s, 25° C., further preferably with a viscosity of 150-400 mm²/s, 25° C.

23. The composition of claim 15, wherein the composition mass hydrophobizes cement-based materials; and/or
wherein the composition mass hydrophobizes cement-based materials to reduce the strength loss.

24. A waterproof composition, comprising:
a composition comprising Component (1) Silicone Hydrophobic Agents and a Component (2) Polyether-modified Polysiloxane of formula I; 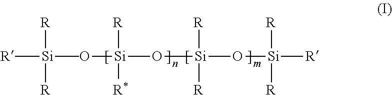
wherein each R independently represents a monovalent hydrocarbon radical having from 1 to 30 carbon atoms, preferably monovalent hydrocarbon radical having from 1 to 6 carbon atoms, more preferably monovalent alkyl radical having from 1 to 6 carbon atoms, such as methyl, ethyl radicals;
wherein R′ independently represents R or R*;
wherein R*═R³—[(C₂H₄O)ₓ(C₃H₆O)_{y}]R⁴;
wherein R³═—(CH₂)ₚO—, p selected from 2-10; preferably 2, 3, 4, 5, 6, more preferably 3 or 4; R⁴ selected from hydrogen, alkyl, aralkyl, aryl or R—C(O)—, preferably hydrogen, methyl, acetyl, more preferably hydrogen and methyl;
wherein x is selected from 1-60, preferably 1-40, more preferably 1-20;
wherein y is selected from 0-60, preferably 0-40, more preferably 0-20;
wherein the value of x plus y is selected from 2-60, preferably 3-40, more preferably 10-30;
wherein n is selected from 0-20, preferably 0-15, more preferably 0-10;
wherein m is selected from 1-20, preferably 5-20, more preferably 5-15;
wherein the value of n plus m is selected from 3-40, preferably 5-30 more preferably 10-20;
wherein when n=0, at least one R′ is selected from R*; and
wherein the waterproof composition comprises 20-60 wt % of the composition, 35-75 wt % water, and 0.1-5 wt % an emulsifier, preferably 30-55 wt % of the composition, 40-65 wt % water, and 0.1-5 wt % an emulsifier, or more preferably 35-50 wt % of the composition, 40-65 wt % water, and 0.1-5 wt % an emulsifier.

25. The waterproof composition of claim 24, wherein the composition mass hydrophobizes cement-based materials; and/or
wherein the composition mass hydrophobizes cement-based materials to reduce the strength loss.

26. The waterproof composition of claim 24, wherein the waterproof composition comprises 10-50 wt % of the composition and 50-90 wt % solid carriers, preferably 15-40 wt % of the composition and 60-85 wt % solid carriers, or more preferably 20-30 wt % of the composition and 70-80 wt % solid carriers.

27. Waterproof cement-based materials, comprising:
a composition comprising Component (1) Silicone Hydrophobic Agents and a Component (2) Polyether-modified Polysiloxane of formula I; 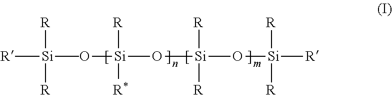
wherein each R independently represents a monovalent hydrocarbon radical having from 1 to 30 carbon atoms, preferably monovalent hydrocarbon radical having from 1 to 6 carbon atoms, more preferably monovalent alkyl radical having from 1 to 6 carbon atoms, such as methyl, ethyl radicals;
wherein R′ independently represents R or R*;
wherein R*═R³—[(C₂H₄O)ₓ(C₃H₆O)_{y}]R⁴;
wherein R³═—(CH₂)ₚO—, p selected from 2-10; preferably 2, 3, 4, 5, 6, more preferably 3 or 4; R⁴ selected from hydrogen, alkyl, aralkyl, aryl or R—C(O)—, preferably hydrogen, methyl, acetyl, more preferably hydrogen and methyl;
wherein x is selected from 1-60, preferably 1-40, more preferably 1-20;
wherein y is selected from 0-60, preferably 0-40, more preferably 0-20;
wherein the value of x plus y is selected from 2-60, preferably 3-40, more preferably 10-30;
wherein n is selected from 0-20, preferably 0-15, more preferably 0-10;
wherein m is selected from 1-20, preferably 5-20, more preferably 5-15;
wherein the value of n plus m is selected from 3-40, preferably 5-30 more preferably 10-20;
wherein when n=0, at least one R′ is selected from R*; and
wherein the composition is present as an active ingredient within the water-proof cement based material in a dosage of 0.1-3 wt % by mass of total cement, preferably 0.1-2 wt %, preferably from 0.1% to 1%.

28. The waterproof cement-based materials of claim 27, wherein the composition accounts for at least 95 wt %, preferably at least 98 wt %, more preferably at least 99 wt % of the total weight of the active ingredients within the waterproof cement-based materials.

29. Waterproof cement-based materials of claim 27, wherein the waterproof cement-based materials have the Rate of Decrease in 24 h Water Absorption of higher than 72% and Retention of Compressive Strength-28d higher than 80% based on Blank without water-repellent admixtures, tested according to JGJ/T 70-2009.
